(19) United States
(12) Patent Application Publication
(10) Pub. No.: US 2026/0190170 A1
(43) Pub. Date: Jul. 2, 2026

(54) Unified Mechanism for Multi-Link Operating Modes and Operating Parameters Updates

(71) Applicant: Cisco Technology, Inc., San Jose, CA (US)

(72) Inventors: Binita Gupta, San Diego, CA (US); Brian D. Hart, Sunnyvale, CA (US); Malcolm M. Smith, Richardson, TX (US)

(73) Assignee: Cisco Technology, Inc., San Jose, CA (US)

(21) Appl. No.: 19/437,849

(22) Filed: Dec. 31, 2025

Related U.S. Application Data
(60) Provisional application No. 63/829,867, filed on Jun. 25, 2025.
(60) Provisional application No. 63/740,826, filed on Dec. 31, 2024.

(51) Int. Cl. H04W 76/15; H04W 8/22; H04W 76/20

(52) U.S. Cl. CPC H04W 76/15; H04W 8/22; H04W 76/20

(57) ABSTRACT

Unified mechanisms for multi-link (ML) operating modes and operating parameters updates may be provided. Updating operating modes and operating parameters can include establishing, by a non-access point (AP) ML device (MLD), a connection with an AP MLD, wherein the establishing comprises establishing one or more links between the non-AP MLD and the AP MLD. The non-AP MLD can determine a non-AP MLD update comprising any one of: (i) disabling one or more operating modes for any of the one or more links, (ii) enabling one or more operating modes for any of the one or more links, (iii) updating one or more operating parameters for any of the one or more links, or (iv) any combination of (i)-(iii). The non-AP MLD sends over a link of the one or more links, a frame to the AP MLD, the frame comprising an element indicating the non-AP MLD update.

### RELATED APPLICATION

Under provisions of 35 U.S.C. § 119(e), Applicant claims the benefit of and priority to U.S. Provisional Application No. 63/740,826, filed December 31, 2024, and U.S. Provisional Application No. 63/829,867, filed June 25, 2025, the disclosures of which are incorporated herein by reference in their entirety.

### TECHNICAL FIELD

The present disclosure relates generally to providing unified mechanisms for multi-link operating modes and operating parameters updates.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for unified mechanisms for multi-link operating modes and operating parameters updates in accordance with aspects of the present disclosure.

FIG. 2 is a block diagram illustrating an example multi-link (ML) operating mode notification (OMN) frame in accordance with aspects of the present disclosure.

FIG. 3 is a block diagram illustrating an example ML OMN element in accordance with aspects of the present disclosure.

FIG. 4 is a block diagram illustrating an example per-Station (STA) profile subelement in accordance with aspects of the present disclosure.

FIG. 5 is a block diagram illustrating an example STA Control field for a reconfiguration ML element in accordance with aspects of the present disclosure.

FIG. 6 is a block diagram illustrating an example STA Info field for a reconfiguration ML element in accordance with aspects of the present disclosure.

FIG. 7 is a block diagram illustrating an example presence bitmap field for an ML OMN element in accordance with aspects of the present disclosure.

FIG. 8 is a block diagram illustrating an example common info field for an ML OMN element in accordance with aspects of the present disclosure.

FIG. 9 is a flow chart of a method for updating multi-link operating modes and operating parameters in accordance with aspects of the present disclosure.

FIG. 10 is a block diagram of a computing device in accordance with aspects of the present disclosure.

FIG. 11 is a block diagram of a computing device in accordance with aspects of the present disclosure.

### DETAILED DESCRIPTION

### OVERVIEW

Unified mechanisms for multi-link (ML) operating modes and operating parameters updates may be provided. Updating operating modes and operating parameters can include establishing, by a non-access point (AP) ML device (MLD), a connection with an AP MLD, wherein the establishing comprises establishing one or more links between the non-AP MLD and the AP MLD. The non-AP MLD can determine a non-AP MLD update comprising any one of: (i) disabling one or more operating modes for any of the one or more links, (ii) enabling one or more operating modes for any of the one or more links, (iii) updating one or more operating parameters for any of the one or more links, or (iv) any combination of (i)-(iii). The non-AP MLD sends over a link of the one or more links, a frame to the AP MLD, the frame comprising an element indicating the non-AP MLD update.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

With advancements in wireless networking operations, such as those described in the Institute of Electrical and Electronics Engineers (IEEE) 802.11bn standard for Ultra High Reliability (UHR) wireless communication systems, multiple new link-specific features and operating modes are being introduced to enhance communication between Access Points (APs) and non-AP Stations (STAs). These features include Dynamic Power Save (DPS) mode, Dynamic Unavailability Operation (DUO) mode (which may be triggered by in-device coexistence (IDC) considerations), Limited Operation mode, Adaptive Operation mode, Non Primary Channel Access (NPCA) mode, Dynamic Subchannel Operation (DSO) mode, and Dynamic Bandwidth Selection (DBS) mode (e.g., Dynamic Bandwidth Expansion (DBE)).

Each of these operating modes provides distinct functionality to optimize wireless communication performance under varying conditions. However, the operation of wireless devices in modern multi-link environments requires dynamic management capabilities. A non-AP STA may need to enable or disable any of these operating modes on one or more links or may need to update operating parameters associated with these operating modes and other features in response to changing network conditions, device states, policies, user requirements, etc. Under conventional approaches, implementing separate signaling mechanisms for each individual feature would result in significant protocol complexity, increased signaling overhead, and undesirable delays in propagating operating mode changes and parameter updates across multiple links. This proliferation of feature-specific mechanisms would burden both the standard specification and device implementations, while creating inefficiencies in network operations.

Unified mechanisms for managing operating modes and their associated operating parameters across multiple links are provided to address these challenges. Rather than defining separate control mechanisms for each feature (e.g., operating mode), a common framework enables a non-AP STA to efficiently enable, disable, and update operating parameters for one or more of the aforementioned features. The unified mechanisms minimize signaling overhead by allowing multiple operating mode changes and corresponding parameter updates to be communicated in consolidated messages. The approach also reduces delays associated with operating mode transitions and parameter updates by enabling efficient batch processing of changes across multiple links and multiple features simultaneously. The simplified protocol design reduces implementation complexity and enhances the responsiveness of wireless devices to dynamic operating conditions while maintaining backward compatibility with existing IEEE 802.11 standards.

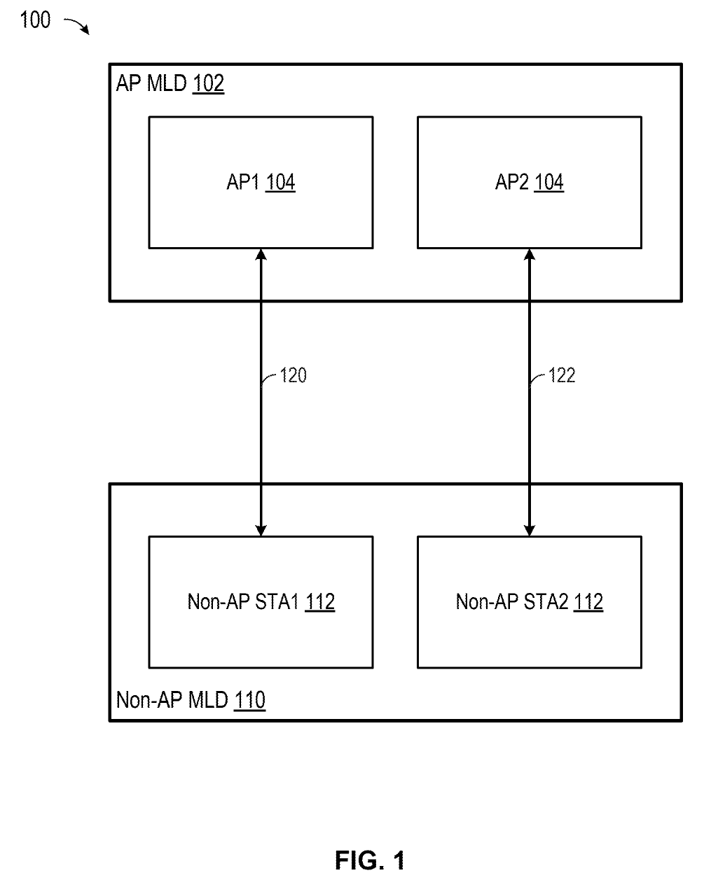

FIG. 1 is a block diagram of an operating environment for unified mechanisms for multi-link operating modes and operating parameters updates. The operating environment 100 includes an AP MLD 102. The AP MLD 102 includes two affiliated APs: the APs 104 illustrated as AP1 104 and AP2 104. The operating environment 100 also includes a non-AP MLD 110. The non-AP MLD 110 includes two affiliated non-AP STAs 112 illustrated as the non-AP STA1 112 and non-AP STA2 112. In the illustrated embodiment, the AP MLD 102 and the non-AP MLD 110 have a first link 120 and a second link 122 setup for connectivity. In an example implementation, the first link 120 is a 5 Gigahertz (GHz) link, and the second link is a 6 GHz link.

The AP MLD 102 and/or the non-AP MLD 110 can include a different number of affiliated APs and STAs respectively in other embodiments. Thus, the AP MLD 102 and the non-AP MLD 110 can include another amount of links setup between them in further example implementations. For example, the non-AP MLD 110 may have a 2.4 GHz link, a 5 GHz link, and a 6 GHz link setup with the AP MLD 102. Additionally, the operating environment 100 can include additional devices, such as additional non-AP MLDs 110 in the same Basic Service Set (BSS) of the AP MLD 102.

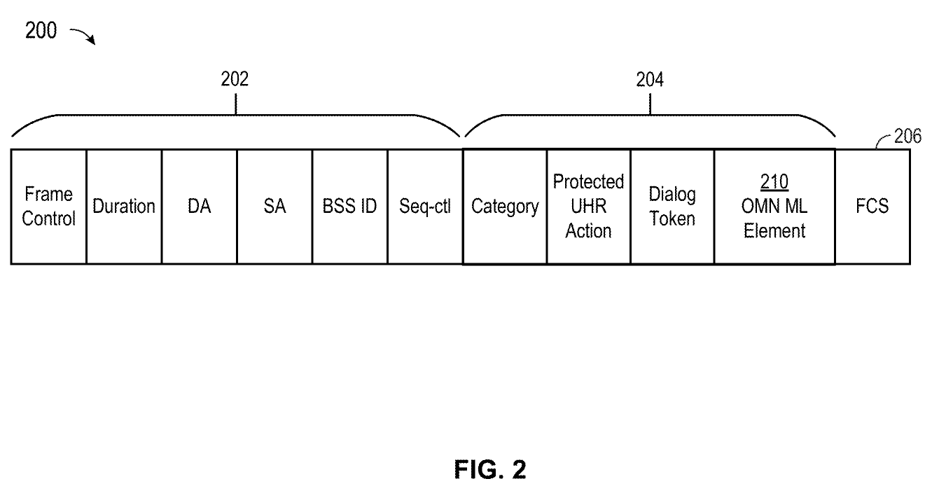

The AP MLD 102 and the non-AP MLD 110 use a common UHR OMN framework configured for use across multiple link specific features (e.g., operating modes), including cross-link signaling of operating mode changes, simultaneous operating mode updates for multiple links, and concurrent updates for multiple operating mode features, all within a single frame structure. The AP MLD 102 and the non-AP MLD 110 can use various frames and elements of the common UHR OMN framework for communicating this information, as will be described in further detail herein with respect to FIGS. 2-8.

For the link specific operating modes, such as DPS, NPCA, DUO, DSO, and DBS, the non-AP MLD 110 may signal the enablement or disablement of operating modes, or communicate operating parameter updates for these operating modes, from any available link (e.g., the first link 120 and the second link 122). For example, the non-AP MLD 110 can signal the enabling of the DPS mode and the DPS parameters for the second link 122 from the first link 120. This cross-link signaling capability avoids the need for the non-AP MLD 110 to switch to a specific link solely for the purpose of signaling operating mode changes for that link. Additionally, the cross-link signaling capability reduces latency and conserves power by allowing the non-AP MLD 110 to utilize whichever link is currently active or most efficient for operating mode update signaling.

The non-AP MLD 110 can modify operating modes or parameters for multiple links within a single frame transmission. For example, the non-AP MLD 110 signals enabling the NPCA mode on both the first link 120 and the second link 122 via a single frame. This capability reduces signaling overhead, processing burden, and time delays that would result from transmitting separate operating mode update or change. By consolidating multi-link changes into a single frame, the mechanism reduces airtime consumption and accelerates the propagation of configuration changes across the non-AP MLD 110.

Additionally, the non-AP MLD 110 can update operating modes for multiple features (e.g., operating modes) simultaneously within the same frame. For example, the non-AP MLD 110 updates parameters for DPS and NPCA in a single frame. This allows efficient coordination of related operating mode changes that may need to occur together in response to a particular trigger event or condition change, further minimizing signaling overhead and ensuring temporal consistency of multi-feature configuration updates.

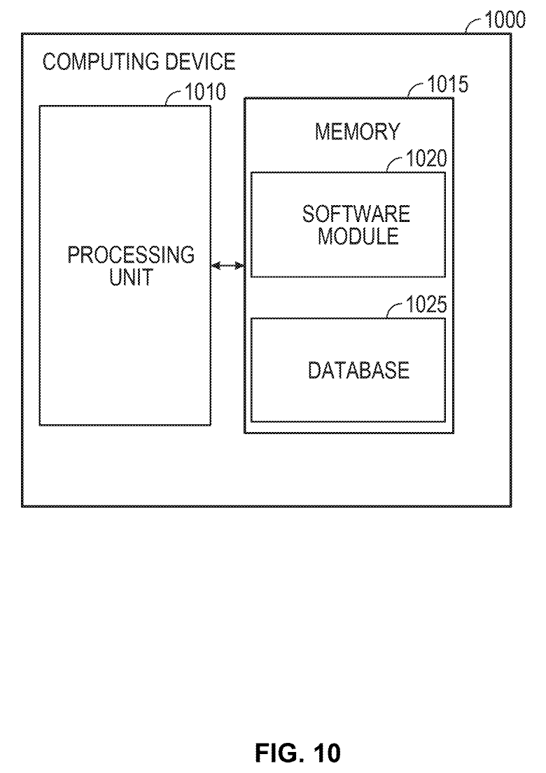

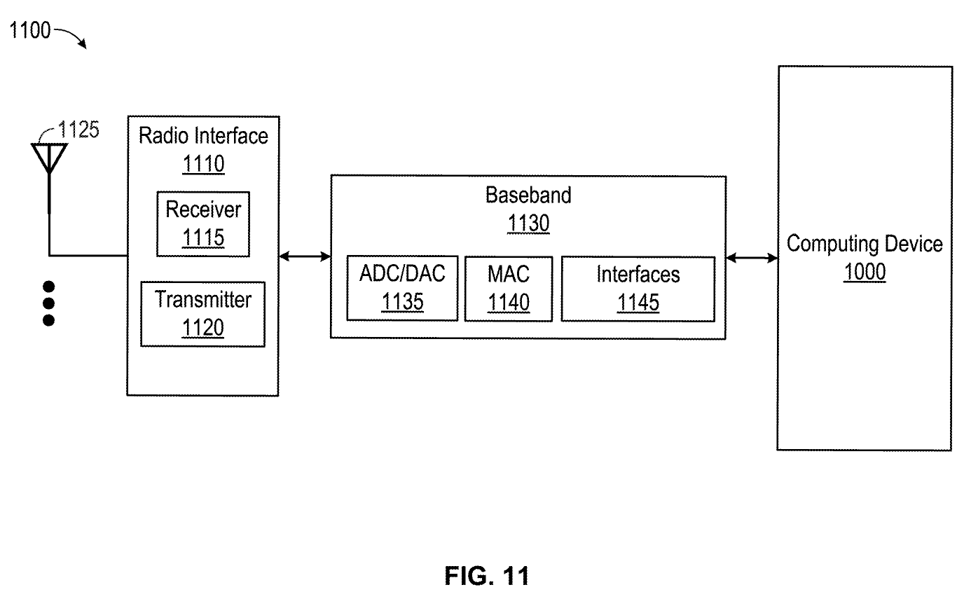

The elements described above of the operating environment 100 (e.g., the AP MLD 102, the APs 104, the non-AP MLD 110, the non-AP STAs 112, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 10 and 11, the elements of the operating environment 100 may be practiced in a computing device 1000 and/or communications device 1100.

### ML Operating Mode Notification (OMN) Frame

FIG. 2 is a block diagram illustrating an example ML OMN frame 200 in accordance with aspects of the present disclosure. FIGS. 2, 3, 4, 7, and 8 illustrate example components of the ML OMN frame 200. However, the ML OMN frame 200 structure can vary in additional embodiments. In example implementations, the ML OMN frame 200 is sent as an encrypted or otherwise protected frame, such as using protected management frame (PMF) protection.

Devices, such as the AP MLD 102 and the non-AP MLD 110, can use the ML OMN frame 200 for cross-link signaling of operating mode changes, simultaneous operating mode updates for multiple links, and concurrent updates for multiple operating modes. Thus, the ML OMN frame 200 enables the management of DPS, NPCA, DUO, DSO, and DBS (e.g., DBE), among other features and operating modes. In example implementations, the non-AP MLD 110 is configured to transmit the ML OMN frame 200 to enable and disable operating modes and/or update operating parameters for one or more of the operating modes for one or more links. In response to receiving an ML OMN frame 200 from the non-AP MLD 110, the AP MLD 102 can transmit a ML OMN frame 200 to confirm some or all of the requested changes have been made, reject some or all of the changes, and/or provide alternate suggestions.

In the illustrated embodiment, the ML OMN frame 200 comprises a header 202, a body 204, and a frame check sequence (FCS) field 206. The ML OMN frame 200 can be any frame devices use for communicating using IEEE 802.11 protocols, including action frames and management frames. The header 202 can include a frame control field, a duration field, a destination address field, a source address field, a BSS identifier (ID) field, and a sequence-control field in certain embodiments. The FCS field 206 can be included to ensure data integrity during transmission of the ML OMN frame 200.

In the illustrated embodiment, the body 204 includes a category field, a protected UHR action field, a dialog token field, and an ML OMN element 210. The category field has a value indicating the category of action frame. The protected UHR action field differentiates protected UHR frame formats for identifying the action the device wants to perform when sending the ML OMN element 210. The dialog token field includes a unique nonzero value for identifying the frame exchange.

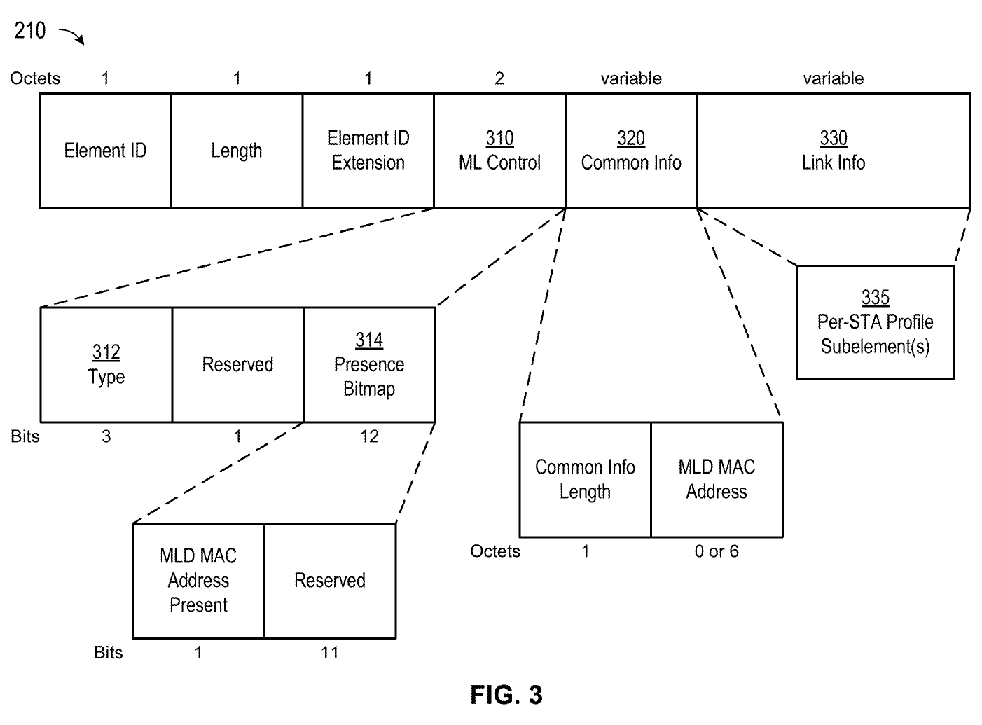

FIG. 3 is a block diagram illustrating an example ML OMN element 210. The ML OMN element 210 includes an element ID field, a length field, an element ID extension field, a ML control field 310, a common info field 320, a link info field 330, and one or more per-STA profile subelements 335. The element ID field and the element ID extension field identify the ML OMN element 210, and the length field identifies the length of the ML OMN element 210. The link info field 330 carries information specific to links of the transmitting device, such as the first link 120 and the second link 122. The link info field 330 includes the one or more per-STA profile subelements 335.

The ML control field 310 defines the type value for the ML OMN element 210 and includes a type field 312, a reserved field, and a presence bitmap field 314 in the illustrated embodiment. The type field 312 indicates the type value for identifying the ML element to be an ML OMN element 210 used for the unified ML OMN framework. The presence bitmap field 314 indicates whether MLD Media Access Control (MAC) address is present in the ML OMN element 210. For example, a MLD MAC address present field is set to one to indicate the presence of an MLD MAC address in the ML OMN element 210 and zero otherwise.

The common info field 320 indicates the length of the common info field 320 in a common info length field and one or more MLD MAC addresses, if the MAC addresses are included, in a MLD MAC address field. The MLD MAC address included in the ML OMN element 210 is the MLD MAC address of the MLD for which operating modes and/or operating parameter updates are being requested. For example, when the non-AP MLD 110 requests an update to its operating modes or operating parameters, the MLD MAC address is the MAC address of the non-AP MLD 110.

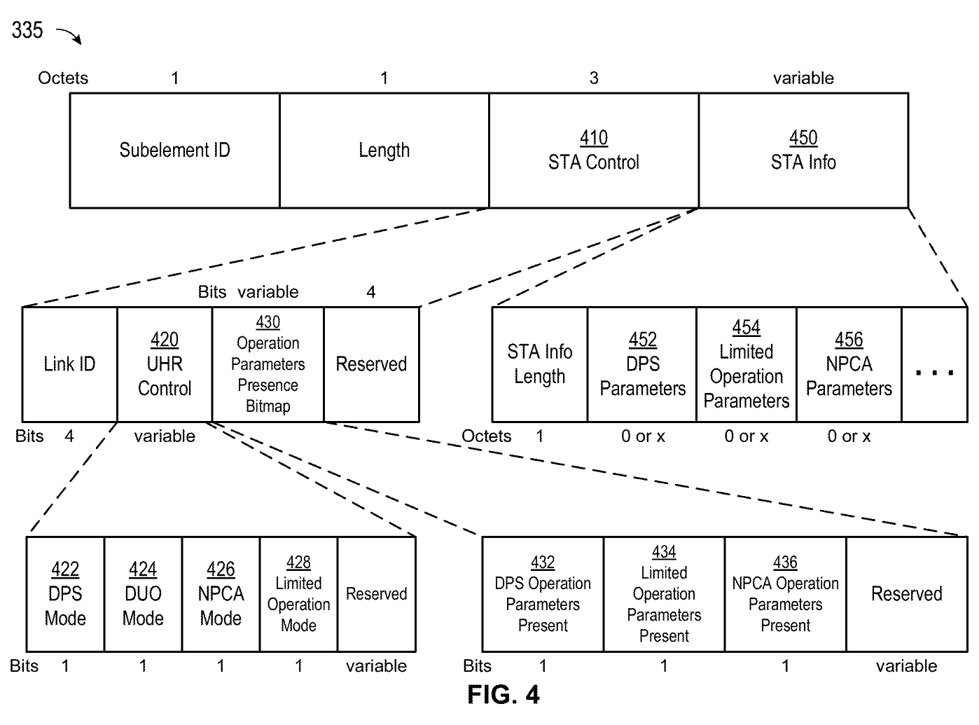

FIG. 4 is a block diagram illustrating an example per-STA profile subelement 335. A per-STA profile subelement 335 in the ML OMN element 210 indicates requested updates for enabling or disabling operating modes and/or updating operating parameters for a specific link. For example, the ML OMN element 210 can include one per-STA Profile subelement 335 for providing updates to the first link 120 and/or a second per-STA Profile subelement 335 for providing updates to the second link 122.

In the illustrated embodiment, the per-STA profile subelement 335 includes a subelement ID field, a length field, an STA control field 410, and an STA info field 450. The subelement ID field identifies the per-STA profile subelement 335, and the length field indicates the per-STA profile subelement 335 length. In some embodiments, the per-STA profile subelement 335 includes a STA profile field.

The STA control field 410 includes the link ID for the link for which the operating modes and/or operating parameters updates is being provided (e.g., the first link 120 or the second link 122). The STA control field 410 further includes a UHR control field 420 that indicates one or more operating modes that is being requested to be enabled by setting the corresponding bit to one or disabled by setting the bit to zero. For example, the UHR Control field 420 can specify a request to enable or disable one or more of the operating modes including DPS in a DPS mode field 422, DUO in a DUO mode field 424, NPCA in a NPCA mode field 426, Limited Operations in a Limited Operations mode field 428, DSO in a DSO mode field not illustrated, DBS in a DBS mode field not illustrated, and so on. Any combination of operating mode fields can be included in the UHR control field 420 for allowing the non-AP MLD 110 to request enablement or disablement of various modes. The UHR control field 420 can vary in length depending on the mode fields that are included (e.g., four, six, eight, ten, or sixteen bits long).

The STA control field 410 also includes an operation parameters presence bitmap field 430 to indicate the presence of one or more operating parameters updates (e.g., corresponding to the operating modes signaled in the UHR control field 420) included in the STA info field 450. The operation parameters presence bitmap field 430 can include bit fields for any combination of parameter types that may be present in the STA info field 450. Each bit field can be set to one to indicate the parameters are present or set to zero to indicate the parameters are not present in the STA info field 450. In the illustrated embodiment, the operation parameters presence bitmap field 430 includes a DPS operation parameters present field 432 to indicate whether parameters for DPS are present, a Limited Operations parameters present field 434 to indicate the presence of parameters for LO, and a NPCA parameters present field 436 to indicate the presence of parameters for NPCA. The operation parameters presence bitmap field 430 can vary in length depending on the number of bit fields included to indicate the presence of various parameters (e.g., four, six, eight, ten, or sixteen bits long).

The STA info field 450 includes a STA info length field indicating the length of the STA info field 450 and one or more sets of operating parameters for various operating modes. In the illustrated embodiment, the STA info field 450 includes a DPS parameters field 452, a Limited Operations parameters field 454, and a NPCA parameters field 456 for indicating parameters of DPS, LO, and NPCA, respectively. Other operating parameters can also be included in the STA info field 450, e.g. DSO parameters, DBE parameters, and so on in further embodiments. If an operating mode is indicated to be disabled, then no operating parameters may be provided for that mode. When enabling an operating mode or updating parameters for an operating mode, the operating parameters may be provided if applicable for that mode. In certain embodiments, the operating modes and operating parameters may be included in a STA profile field that is included in the per-STA profile subelement 335. The operating modes and operating parameters may be provided in an element that is carried in the STA profile field.

In certain embodiments, the UHR control field 420 or its mode fields are provided in the STA info field 450 instead of the STA control field 410. The operation parameters presence bitmap field 430 can also include fields to indicate the presence of the UHR control field 420 or the mode fields in the STA info field 450 in these embodiments. Thus, the DPS mode field 422, the DUO mode field 424, the NPCA mode field 426, and the Limited Operations mode field 428 may be in the STA info field 450 along with the operating parameters fields. In example implementations, the mode fields can also indicate whether a respective parameters field includes updates. In further embodiments, the STA control field 410 can include a single bit that indicates there are updates present in the STA info field 450, and the operation parameters presence bitmap field 430 or another presence bitmap is included in the STA info field 450. In some embodiments, the updates are in one or more subelements or elements in the STA info field 450 instead of using the fields.

In certain embodiments, the non-AP MLD 110 may determine to update operating modes and/or parameters for multiple links, such as the first link 120 and the second link 122. To apply updates to both links in the same ML OMN frame 200, the non-AP MLD 110 can include mode fields and/or parameter fields in the common info field 320. The same operating mode and parameters updates can then be applied for both links using the common info field 320 instead of including two separate per-STA profile subelements 335 for each link. The common info field 320 can include a presence bitmap to indicate the presence of mode fields and/or parameters fields. Additionally, the non-AP MLD 110 can include common updates for both links in the common info field 320 and link specific updates in respective per-STA profile subelements 335 in the same ML OMN frame 200.

In some embodiments, the AP MLD 102 responds to one or more operating mode and/or parameter updates in an ML OMN frame 200 from the non-AP MLD 110 with a new ML OMN frame 200. In other embodiments, the AP MLD 102 can send a ML OMN response frame having a different format for indicating the status outcome for the requested operating mode changes and/or operating parameter updates. The ML OMN response frame can include a single status field for providing the status to the non-AP MLD 110. For example, the AP MLD 102 can return a ‘success’ status when the AP MLD 102 is able to successfully accept or otherwise update the operating modes and operating parameters for all the requested modes. If the AP MLD 102 is not able to accept and/or update the operating modes and parameters for one or more requested modes, the AP MLD 102 can return a ‘rejection' status outcome in the response frame, with a specific status code indicating a specific reason for rejection. The non-AP MLD 110 can then send a follow-up ML OMN frame 200 that does not include the request for the operating mode that failed in the previous request or otherwise modify the request. When the AP MLD 102 uses a ML OMN frame 200 to indicate the status, a 'Status' field may be included and populated to indicate the success and rejection of updates.

Instead of using the ML OMN frame 200, the non-AP MLD 110 can include the ML OMN element 210 in a (Re)Association Request frame to provide updates to operating modes and/or operating parameters to the AP MLD 102 in some embodiments. The AP MLD 102 can return a ML OMN element 210 in the (Re)Association Response frame to indicate the enabled operating modes and/or latest operating parameters that the AP MLD 102 has accepted. In other embodiments, the AP MLD 102 does not include the ML OMN element 210 in the (Re)Association Response frame, and the absence of this element signals to the non-AP MLD 110 that the AP MLD 102 has accepted the requested operating modes and/or operating parameters. The AP may also indicate a rejection and provide alternate suggestions for operating modes and/or operating parameters in the (Re)Association Response frame, using the ML OMN element 210 for example.

### UHR Frame with Reconfiguration ML Element

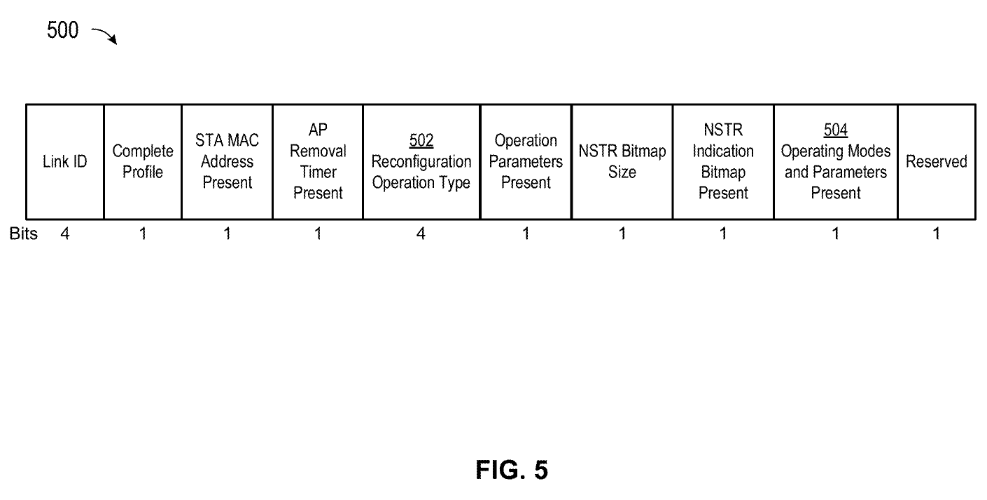

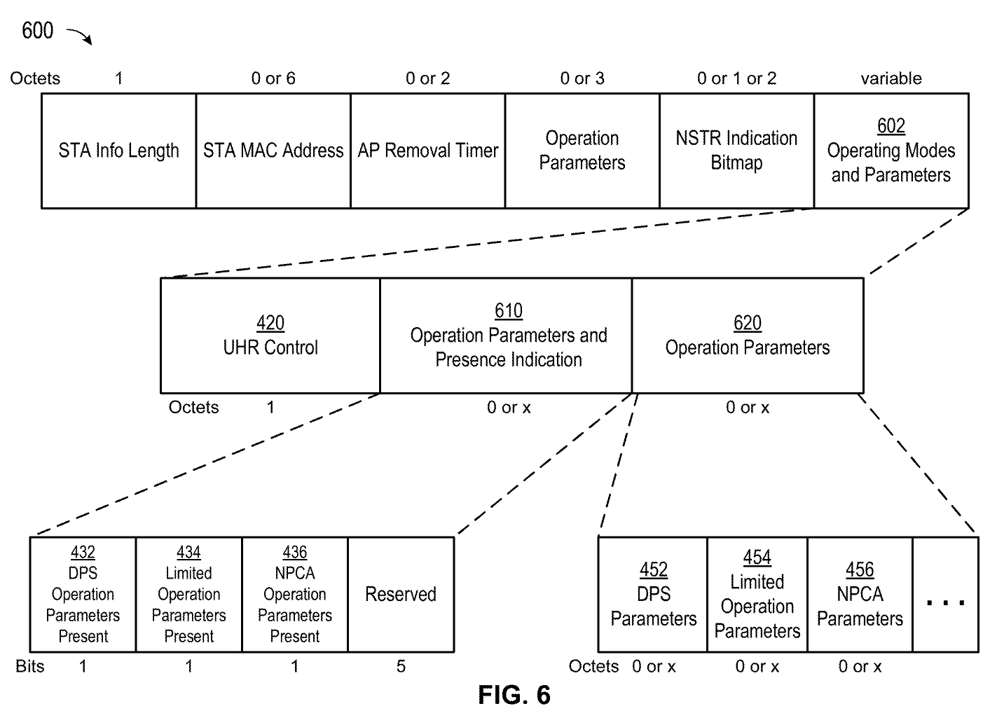

In certain embodiments, devices, such as the AP MLD 102 and the non-AP MLD 110, can use another UHR frame defined for OMN that includes a reconfiguration ML element for cross-link signaling of operating mode changes, simultaneous operating mode updates for multiple links, and concurrent updates for multiple operating modes. The UHR frame could be any UHR frame defined for OMN (e.g., a UHR link reconfiguration request frame, A UHR link reconfiguration notify frame) that includes a reconfiguration ML element. The reconfiguration ML element is defined in the IEEE 802.11be standard and is used to announce an ML reconfiguration operation, such as reconfiguring existing links and adding or deleting links to an existing ML setup. The reconfiguration ML element is enhanced for use as part of the unified ML OMN framework, as will be described herein with respect to FIG. 5 and FIG. 6. Therefore, the ML OMN frame 200 and/or other UHR frames that include a reconfiguration ML element enable the management of DPS, NPCA, DUO, DSO, and DBS, among other features and operating modes. The AP MLD 102 can also respond with a UHR frame to indicate success, failure, and other information to the non-AP MLD 110. In some embodiments, the UHR frame used of unified ML OMN framework can be encrypted or otherwise protected (e.g., using PMF protection).

The reconfiguration ML element can include a common info field and one or more per-STA profile subelements, where each per-STA profile subelement can provide operating mode updates for a specific link. To provide operating mode updates for multiple links, multiple per-STA profile subelements are included in the reconfiguration ML element. In some embodiments, if same operating mode updates apply across all links, then those updates can be provided in the common info field as further described herein.

FIG. 5 is a block diagram illustrating an example STA control field 500 for a per-STA profile subelement included in a reconfiguration ML element. The reconfiguration ML element is enhanced with a new reconfiguration operation type value for the reconfiguration operation type field 502 that indicates the presence of operating mode and parameters updates. An operating modes and parameters present field 504 is also added to the STA control field 500 when the reconfiguration operation type field 502 is set to indicate operating modes and parameters updates. The operating modes and parameters present field 504 indicates an operating modes and parameters field 602 is present in the STA info field 600 of the reconfiguration ML element. In some embodiments, the reconfiguration operation type field 502 is set to indicate operating mode updates, a request to add a new link and operating mode updates, or a request to add a link. When the reconfiguration operation type field 502 indicates a request to add a link, the type field in the UHR link reconfiguration request frame that is carrying the reconfiguration ML element can indicate operating mode updates and/or a request to add a new link.

FIG. 6 is a block diagram illustrating an example STA info field 600 of a per-STA profile subelement included in a reconfiguration ML element. The operating modes and parameters field 602 specifies operating modes to be enabled and/or operating parameters to be updated. In the illustrated embodiment, the operating modes and parameters field 602 includes the UHR control field 420 indicating the operating modes to enable or disable. An operation parameters and presence indication field 610 indicates the presence of one or more operating parameters like the operation parameters presence bitmap field 430. An operation parameters field 620 includes the operating parameters for one or more operating modes like the parameter fields 452, 454, 456 in the STA info field 450. The STA control field 500, the STA info field 600, and other portions of the reconfiguration ML element can have different structures or formats for indicating the updates to the operating modes and the operating parameters in additional embodiments.

In some embodiments, the operating modes and operating parameters are included in the STA profile field of the per-STA profile subelement in the reconfiguration ML element. The operating modes and operating parameters may be provided in an element that is carried in the STA profile field. In the per-STA profile subelement of a reconfiguration ML element, if an operating mode is indicated to be disabled, then no operating parameters are provided for that mode. If an operating mode is being enabled or operating parameters are being updated for an operating mode, then the operating parameters are included for that mode, if applicable.

In certain embodiments, the non-AP MLD 110 may determine to update operating modes and/or parameters for multiple links, such as the first link 120 and the second link 122, using a UHR frame that carries a reconfiguration ML element. To apply updates to both links, the non-AP MLD 110 can include mode fields and/or parameter fields in the common info field of the reconfiguration ML element. The same operating mode and parameters updates can then be applied for both links using the common info field, instead of including two separate per-STA profile subelements for each link. The common info field can include a presence bitmap to indicate the presence of mode fields and/or parameters fields. Additionally, the non-AP MLD 110 can include common updates for both links in the common info field and link specific updates in respective per-STA profile subelements in the same reconfiguration ML element.

In some embodiments, the enhanced reconfiguration ML element can be included in a (Re)Association Request frame to indicate requested updates to operating modes and/or operating parameters to the AP MLD 102. The AP MLD 102 can return a Reconfiguration ML element in the (Re)Association Response frame to indicate the enabled operating modes and/or latest operating parameters that the AP MLD 102 has accepted. Alternatively, the AP MLD 102 may not include the reconfiguration ML element in the (Re)Association Response frame, and the absence of this element signals that the AP MLD 102 has accepted the requested operating modes and/or operating parameters from the non-AP MLD 110. The AP MLD 102 may also indicate a rejection and provide alternate suggestions for operating modes and/or operating parameters in the (Re)Association Response frame, using the reconfiguration ML element for example.

In certain embodiments, the reconfiguration ML element can be enhanced to only support providing updated operating parameters for one or more operating modes/features. For example, the reconfiguration ML element can be enhanced to provide operating parameters for one or more of DPS, NPCA, Limited Operations modes, DSO, DBS or other operating modes. A new value is defined for the Reconfiguration Operation Type field indicating extended operation parameters updates. The STA Control field 500 can also optionally include an extended operation parameters present bit that indicates presence of an extended operation parameters field in the STA info field 600.

The extended operation parameters field can include an extended operation parameters presence indication field that indicates presence of one or more operating parameters (e.g., by setting the corresponding bit to one), and an extended operation parameters field that includes operating parameters for one or more operating modes. For example, the extended operation parameters field can include one or more of DPS Parameters, Limited Operations Parameters, NPCA parameters, DSO parameters, DBS parameters or parameters for other operating modes.

In some embodiments, the non-AP MLD 110 includes the Reconfiguration ML element with the Extended Operation Parameters in the (Re)Association Request frame to provide its operating parameters to the AP MLD 102 as part of an association process.

In further embodiments, the reconfiguration ML element can be enhanced to define a separate Reconfiguration Operation Type value for each type of operating parameters for which updated values need to be provided by the non-AP MLD 110. For example, a different 'Reconfiguration Operation Type' value can be defined for the DPS parameters, NPCA parameters, DSO parameters, Limited Operation parameters, and so on. The non-AP MLD 110 can provide operating parameters for one of the modes by setting the 'Reconfiguration Operation Type' to the corresponding value. In example implementations, one of the reserved bits in the STA control field 500 can be used to indicate 'Extended STA Control Presence' for extending the STA Control field 500 by adding additional bits or octets for STA control information in the STA Info field 600. For example, the STA info field 600 can include an extended STA control field that indicates the presence of operating parameters for specific modes in the STA Info field 600.

### Updating MLD Level Capabilities

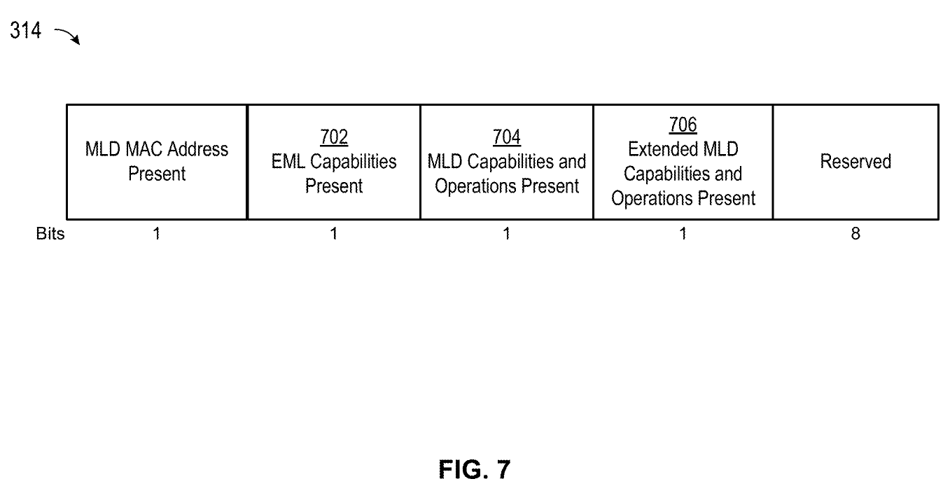

FIG. 7 is a block diagram illustrating an example presence bitmap field 314 for an ML OMN element 210 for enabling devices to update MLD level capabilities and operation parameters. For example, the presence bitmap field 314 and the common info field 320 can be enhanced to update enhanced ML (EML) capabilities, MLD capabilities and operations, extended MLD capabilities and operations as defined in 802.11be, and other MLD level capabilities and operation parameters.

The presence bitmap field 314 includes fields for indicating the presence of MLD level capabilities updates. In the illustrated embodiment, for example, the presence bitmap field 314 includes an EML capabilities present field 702 to indicate updates to EML capabilities, an MLD capabilities and operations present field 704 to indicate updates to MLD capabilities and operations, and an extended MLD capabilities and operations present field 706 to indicate updates to extended MLD capabilities and operations present in the common info field 320.

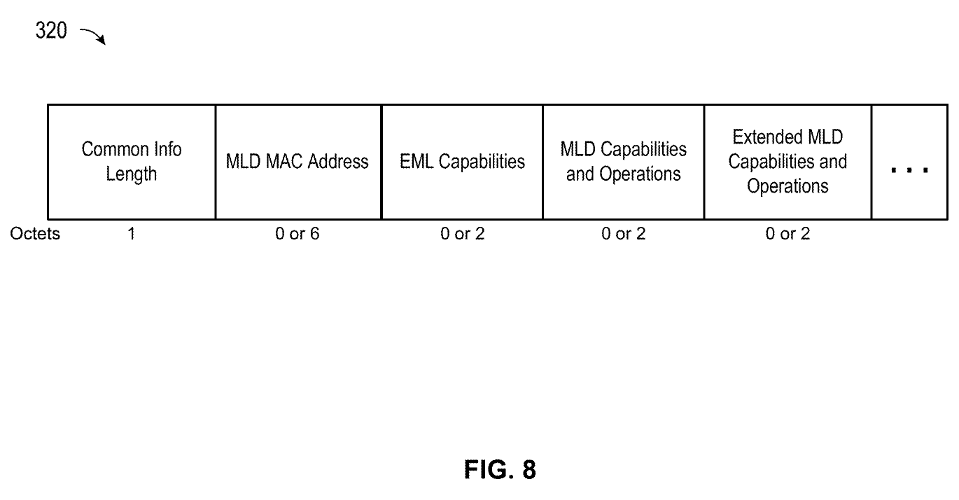

FIG. 8 is a block diagram illustrating an example common info field 320 for an ML OMN element 210 for enabling devices to update MLD level capabilities and operation parameters. The common info field 320 includes one or more sets of updated MLD capabilities and operation parameters. In the illustrated embodiment, the common info field 320 includes EML capabilities in a EML capabilities field 802, MLD capabilities and operations in an MLD capabilities and operations field 804, and extended MLD capabilities and operations in an extended MLD capabilities and operations field 806. Other MLD level capabilities and parameters can also be indicated as present in the presence bitmap field 314 and included in the common info field 320 in additional embodiments.

In some embodiments, the non-AP MLD 110 can use a reconfiguration ML element to provide updates to MLD level capabilities and operation parameters to the AP MLD 102. The reconfiguration ML element includes the MLD level capabilities and operation parameters in the common info field. The non-AP MLD 110 can send to the AP MLD 102 an ML operation update request frame that includes the reconfiguration ML element with the updated MLD level capabilities and operation parameters to provide its updated set of MLD level capabilities and operation parameters.

### Methods

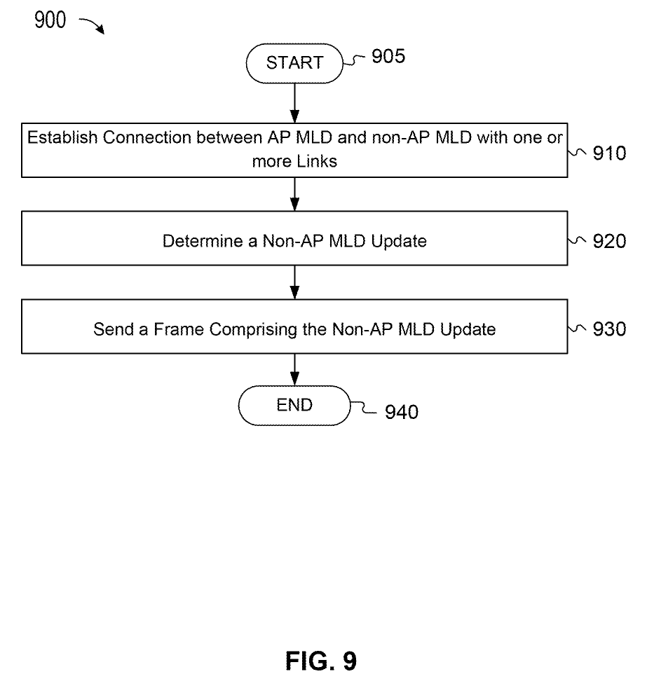

FIG. 9 is a flow chart of a method 900 for updating ML operating modes and operating parameters. The method 900 begins at starting block 905 and proceeds to operation 910. In operation 910, the non-AP MLD 110 establishes a connection with an AP MLD 102. The establishing comprises establishing one or more links between the non-AP MLD 110 and the AP MLD 102, such as the first link 120 and the second link 122. The connection with the AP MLD 102 can be an association with the AP MLD 102 or an association with a seamless mobility domain management entity (SMD-ME) to which the AP MLD 102 belongs. An SMD-ME comprises multiple AP MLDs across which seamless mobility and roaming is supported.

In operation 920, the non-AP MLD 110 determines a non-AP MLD update comprising disabling one or more operating modes for any of the one or more links, enabling one or more operating modes for any of the one or more links, and/or updating one or more operating parameters for any of the one or more links. The update can comprise any of the updates to operating modes and parameters as described herein.

In operation 930, the non-AP MLD 110 sends over a link of the one or more links, a frame to the AP MLD 102. The frame comprising an element indicating the non-AP MLD update. The AP MLD 102 can return a response frame indicating a success, a failure, or suggested changes for the non-AP MLD update. The frame is an ML OMN frame 200 in certain embodiments. In other embodiments, the frame another UHR frame including a reconfiguration ML element. The update can comprise a change for a plurality of links, such as both the first link 120 and the second link 122. In some embodiments, the update includes a change for one link (e.g., the first link 120), and the non-AP MLD 110 sends the frame via a second link (e.g., the second link 122). In some embodiments, the frame further comprises an update to one or more MLD level capabilities and operation parameters of the non-AP MLD 110. The method 900 concludes at ending block 940.

### Systems

FIG. 10 is a block diagram of a computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for updating operating modes and operating parameter with respect to FIGS. 1-8. Computing device 1000, for example, may provide an operating environment for the AP MLD 102, the APs 104, the non-AP MLD 110, the non-AP STAs 112, and the like. The AP MLD 102, the APs 104, the non-AP MLD 110, the non-AP STAs 112, and the like may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples, and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 1000 on the single integrated circuit (chip).

FIG. 11 illustrates an implementation of a communications device 1100 that may implement one or more of the AP MLD 102, the APs 104, the non-AP MLD 110, the non-AP STAs 112, etc., of FIG. 1. In various implementations, the communications device 1100 may comprise a logic circuit. The logic circuit may include physical circuits to perform operations described for one or more of the AP MLD 102, the APs 104, the non-AP MLD 110, the non-AP STAs 112, etc., of FIG. 1, for example. As shown in FIG. 11, the communications device 1100 may include one or more of, but is not limited to, a radio interface 1110, baseband circuitry 1130, and/or the computing device 1000.

The communications device 1100 may implement some or all of the structures and/or operations for the AP MLD 102, the APs 104, the non-AP MLD 110, the non-AP STAs 112, etc., of FIG. 1, storage medium, and logic circuit in a single computing entity, such as entirely within a single device. Alternatively, the communications device 1100 may distribute portions of the structure and/or operations using a distributed system architecture, such as a client station server architecture, a peer-to-peer architecture, a master-slave architecture, etc.

A radio interface 1110, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1110 may include, for example, a receiver 1115 and/or a transmitter 1120. The radio interface 1110 may include bias controls, a crystal oscillator, and/or one or more antennas 1125. In additional or alternative configurations, the radio interface 1110 may use oscillators and/or one or more filters, as desired.

The baseband circuitry 1130 may communicate with the radio interface 1110 to process, receive, and/or transmit signals and may include, for example, an Analog-To-Digital Converter (ADC) for down converting received signals with a Digital-To-Analog Converter (DAC) 1135 for up converting signals for transmission. Further, the baseband circuitry 1130 may include a baseband or Physical layer (PHY) processing circuit for the PHY link layer processing of respective receive/transmit signals. Baseband circuitry 1130 may include, for example, a MAC processing circuit 1140 for MAC/data link layer processing. Baseband circuitry 1130 may include a memory controller for communicating with MAC processing circuit 1140 and/or a computing device 1000, for example, via one or more interfaces 1145.

In some configurations, PHY processing circuit may include a frame construction and/or detection module, in combination with additional circuitry such as a buffer memory, to construct and/or deconstruct communication frames. Alternatively or in addition, MAC processing circuit 1140 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by a non-access point (AP) multi-link device (MLD), a connection with an AP MLD,
wherein the establishing comprises establishing one or more links between the non-AP MLD and the AP MLD;
determining, by the non-AP MLD, a non-AP MLD update comprising any one of: (i) disabling one or more operating modes for any of the one or more links, (ii) enabling one or more operating modes for any of the one or more links, (iii) updating one or more operating parameters for any of the one or more links, or (iv) any combination of (i)-(iii); and
sending, by the non-AP MLD over a link of the one or more links, a frame to the AP MLD, the frame comprising an element indicating the non-AP MLD update.

2. The method of claim 1, further comprising:
receiving, by the non-AP MLD, a response frame indicating a success, a failure, or suggested changes for the non-AP MLD update.

3. The method of claim 1, wherein the frame is a multi-link (ML) operating mode notification (OMN) frame.

4. The method of claim 1, wherein the element is an ML reconfiguration element.

5. The method of claim 1, wherein the non-AP MLD update comprises a change for a plurality of links of the one or more links.

6. The method of claim 1, wherein the non-AP MLD update comprises a change for a first link of the one or more links, and the sending the frame is via a second link of the one or more links.

7. The method of claim 1, wherein the frame further comprises an update to one or more MLD level capabilities and operation parameters of the non-AP MLD.

8. A system comprising:
a memory storage; and
a processing unit coupled to the memory storage, wherein the processing unit is operative to:
establish a connection with an access point (AP) multi-link device (MLD),
wherein the establishing comprises establishing one or more links with the AP MLD;
determine a non-AP MLD update comprising any one of: (i) disabling one or more operating modes for any of the one or more links, (ii) enabling one or more operating modes for any of the one or more links, (iii) updating one or more operating parameters for any of the one or more links, or (iv) any combination of (i)-(iii); and
send, over a link of the one or more links, a frame to the AP MLD, the frame comprising an element indicating the non-AP MLD update.

9. The system of claim 8, the processing unit being further operative to:
receive a response frame indicating a success, a failure, or suggested changes for the non-AP MLD update.

10. The system of claim 8, wherein the frame is a multi-link (ML) operating mode notification (OMN) frame.

11. The system of claim 8, wherein the element is an ML reconfiguration element.

12. The system of claim 8, wherein the non-AP MLD update comprises a change for a plurality of links of the one or more links.

13. The system of claim 8, wherein the non-AP MLD update comprises a change for a first link of the one or more links, and the sending the frame is via a second link of the one or more links.

14. The system of claim 8, wherein the frame further comprises an update to one or more MLD level capabilities and operation parameters.

15. A non-transitory computer-readable medium that stores a set of instructions which when executed perform a method executed by the set of instructions comprising:
establishing a connection with an access point (AP) multi-link device (MLD),
wherein the establishing comprises establishing one or more links with the AP MLD;
determining a non-AP MLD update comprising any one of: (i) disabling one or more operating modes for any of the one or more links, (ii) enabling one or more operating modes for any of the one or more links, (iii) updating one or more operating parameters for any of the one or more links, or (iv) any combination of (i)-(iii); and
sending, over a link of the one or more links, a frame to the AP MLD, the frame comprising an element indicating the non-AP MLD update.

16. The non-transitory computer-readable medium of claim 15, the method executed by the set of instructions further comprising:
receiving a response frame indicating a success, a failure, or suggested changes for the non-AP MLD update.

17. The non-transitory computer-readable medium of claim 15, wherein the frame is a multi-link (ML) operating mode notification (OMN) frame.

18. The non-transitory computer-readable medium of claim 15, wherein the element is an ML reconfiguration element.

19. The non-transitory computer-readable medium of claim 15, wherein the non-AP MLD update comprises a change for a plurality of links of the one or more links.

20. The non-transitory computer-readable medium of claim 15, wherein the non-AP MLD update comprises a change for a first link of the one or more links, and the sending the frame is via a second link of the one or more links.
